(19) United States
(12) Patent Application Publication
(10) Pub. No.: US 2011/0225099 A1
(43) Pub. Date: Sep. 15, 2011

(54) PROPERTY TRANSACTION MANAGEMENT SYSTEM

(76) Inventors: Jean-Sébastien DUFAULT, Sainte-Brigide-d'Iberville (CA); Gilles PLOURDE, Carignan (CA); Jean-François MCNEIL, Montreal (CA); Anderson BRICE, Montreal (CA); Marie-Claude PELLETIER, Carignan (CA)

(21) Appl. No.: 13/047,021

(22) Filed: Mar. 14, 2011

Related U.S. Application Data
(60) Provisional application No. 61/313,269, filed on Mar. 12, 2010.

(51) Int. Cl. G06Q 50/00

(52) U.S. Cl. 705/316

(57) ABSTRACT

There is provided a method for managing property transactions, the method comprising: providing to each user a reserved space for collecting and classifying information relating to a plurality of properties offered for sale, the reserved space including a public space containing information accessible by other users and a private space containing information inaccessible by other users; receiving documents from each user and automatically classifying them according to a pre-determined classification system; automatically transferring documents for registration to governing bodies and completing administrative formalities using information provided in documents received; temporarily linking listings in public spaces for a buying agent and selling agent during the course of a transaction, from receipt of a purchase offer to final rejection or conclusion of the transaction; managing access to the public and private space of a user and transfer of information to another party from a remote location; and recording deadlines from the documents received and automatically notifying users of impending deadlines in accordance with predefined user preferences.

### CROSS-REFERENCE TO RELATED APPLICATIONS

This application claims priority under 35 U.S.C. §119(e) from U.S. Provisional Patent Application No. 61/313,269, filed on Mar. 12, 2010, the contents of which are hereby incorporated by reference.

### TECHNICAL FIELD

The present invention relates to the field of management systems, and more particularly, to management system for real estate agents to manage all aspects of transactions and document filing.

### BACKGROUND

The daily life of a real estate agent involves lots of paperwork and lots of deadlines that have to be met. There are many levels of administration that impose various degrees of obligations. In addition to the administrative obligations, potential buyers and sellers may be quite demanding and expect their real estate agent to be available for them at all times, with all of the information on hand whenever necessary.

Many of the procedures involved in the transaction of a property are still somewhat archaic. For example, certain jurisdictions do not yet recognize electronic signatures and require that a contract be filed with a true signature. While some forms are available online, some of the tools available for real estate agents are far from being optimized.

Therefore, there is a need for improved tools for management of paperwork and information involved in transactions for properties.

### SUMMARY

In accordance with a first broad aspect, there is provided a method for managing property transactions, the method comprising: providing to each user a reserved space for collecting and classifying information relating to a plurality of properties offered for sale, the reserved space including a public space containing information accessible by other users and a private space containing information inaccessible by other users; receiving documents from each user and automatically classifying them according to a pre-determined classification system; automatically transferring documents for registration to governing bodies and completing administrative formalities using information provided in documents received; temporarily linking listings in public spaces for a buying agent and selling agent during the course of a transaction, from receipt of a purchase offer to final rejection or conclusion of the transaction; managing access to the public and private space of a user and transfer of information to another party from a remote location; and recording deadlines from the documents received and automatically notifying users of impending deadlines in accordance with predefined user preferences.

In accordance with a second broad aspect, there is provided a property transaction management system comprising: a processor in a computer system; a memory accessible by the processor; and at least one application coupled to the processor and configured for: providing to each user a reserved space for collecting and classifying information relating to a plurality of properties offered for sale, the reserved space including a public space containing information accessible by other users and a private space containing information inaccessible by other users; receiving documents from each user and automatically classifying them according to a predetermined classification system; automatically transferring documents for registration to governing bodies and completing administrative formalities using information provided in documents received; temporarily linking listings in public spaces for a buying agent and selling agent during the course of a transaction, from receipt of a purchase offer to final rejection or conclusion of the transaction; managing access to the public and private space of a user and transfer of information to another party from a remote location; and recording deadlines from the documents received and automatically notifying users of impending deadlines in accordance with predefined user preferences.

### BRIEF DESCRIPTION OF THE DRAWINGS

Further features and advantages of the present invention will become apparent from the following detailed description, taken in combination with the appended drawings, in which:

FIG. 1 is a schematic illustration of a network involving a property transaction management system, in accordance with one embodiment;

FIG. 2 is a block diagram illustrating a computer system with property transaction management applications running thereon, in accordance with one embodiment;

FIG. 3 is a block diagram illustrating a document/data processing application, in accordance with one embodiment;

FIG. 4 is a block diagram detailing the processing module from FIG. 3, in accordance with one embodiment;

FIG. 5 is a block diagram illustrating a monitoring application, in accordance with one embodiment;

FIG. 7 is a block diagram illustrating a database access application, in accordance with one embodiment;

FIG. 8a is a schematic illustrating an exemplary embodiment of a database holding information for multiple users;

FIG. 8b is a schematic illustrating an exemplary embodiment of multiple databases exchanging information, each database holding information for a single user;

FIG. 9 is a flowchart illustrating a method for processing documents/data, in accordance with one embodiment;

FIG. 10 is a flowchart illustrating a method for monitoring transactions, in accordance with one embodiment;

FIG. 11 is a flowchart illustrating a method for monitoring deadlines, in accordance with one embodiment;

FIG. 12 is a flowchart illustrating a method for external monitoring, in accordance with one embodiment;

FIG. 13 is a flowchart illustrating a method for managing database access, in accordance with one embodiment; and

FIG. 14 is a flowchart illustrating a method for managing changes to information in a database, in accordance with one embodiment.

It will be noted that throughout the appended drawings, like features are identified by like reference numerals.

### DETAILED DESCRIPTION

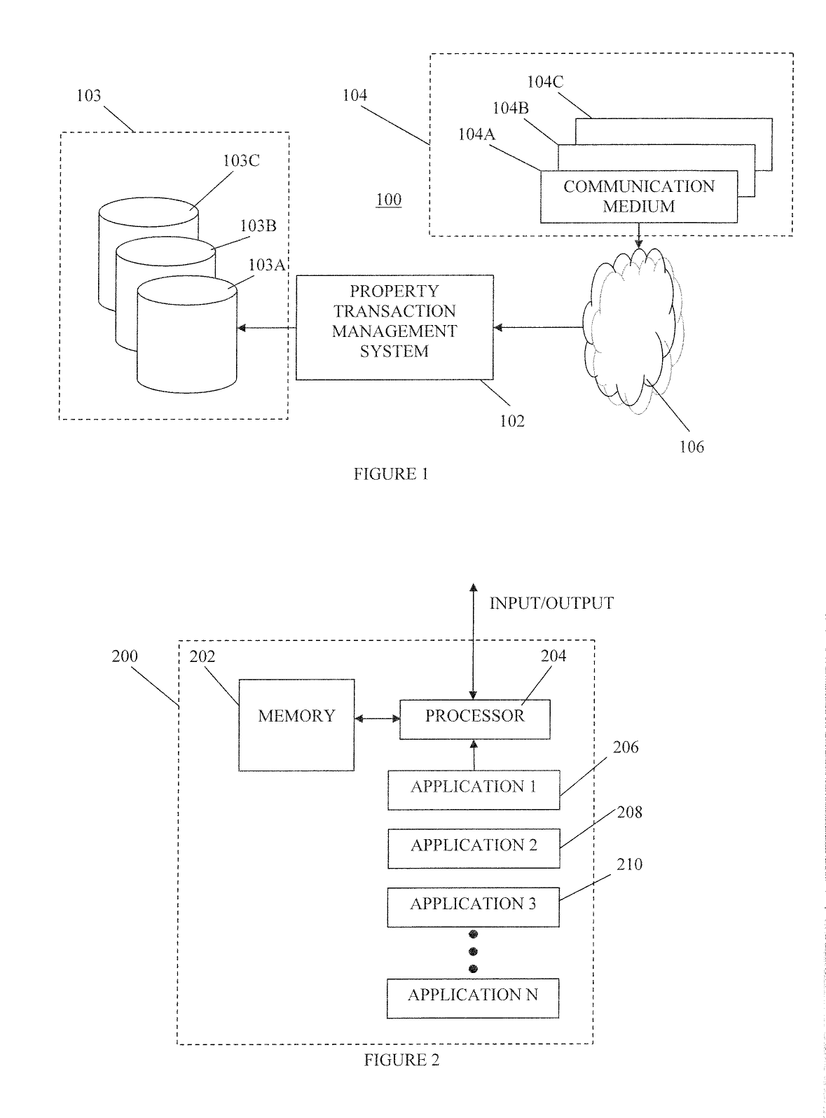

Referring to FIG. 1, there is illustrated a block diagram of an exemplary embodiment of a network 100 comprising a property transaction management system 102. One or more databases 103a, 103b, 103c (collectively referred to as 103) contain various information on the properties for sale, as will be explained in more detail below. More than one database 103a, 103b, 103c may be accessed by the system 102. In one embodiment, one database 103a may contain information related to only a single property for sale. In another embodiment, one database 103a may contain information related to all of the properties for a single agent. The property transaction management system 102 is accessed by a communication medium 104a, 104b, 104c (collectively referred to as 104), such as a telephone, a computer, a personal digital assistant (PDA), an iPhone™, etc, via any type of network 106, such as the Internet, the Public Switch Telephone Network (PSTN), a cellular network, or others known to those skilled in the art. The property transaction management system 102 receives requests from the communication medium 104, and based on those requests, it accesses the database 103 to retrieve the requested information and provide it to the user via the communication medium 104. When a user transfers data in database 103 to another location or to another user, this may be done via the network 106, which can be the same network as that used to access the property transaction management system 102 or a different network.

FIG. 2 illustrates the property transaction management system 102 of FIG. 1 as a plurality of applications 206, 208, 210 running on a processor 204, the processor being coupled to a memory 202. The database 103 may be integrated directly into memory 202 or may be provided separately therefrom and remotely from the property transaction management system 102. In the case of a remote access to the database 103, access may occur via any type of network 106, as indicated above.

The memory 202 accessible by the processor 204 receives and stores data, such as data relating to a property for sale, deadlines that are to be met, statistics logged by the system 102, and any other information used by the property transaction management system 102. The memory 202 may be a main memory, such as a high speed Random Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc.

The processor 204 may access the memory 202 to retrieve data. The processor 204 may be any device that can perform operations on data. Examples are a central processing unit (CPU), a front-end processor, a microprocessor, a graphics processing unit (GPU/VPU), a physics processing unit (PPU), a digital signal processor, and a network processor. The applications 206, 208, 210 are coupled to the processor 204 and configured to perform various tasks as explained below in more detail. An output may be transmitted to a communication medium 104.

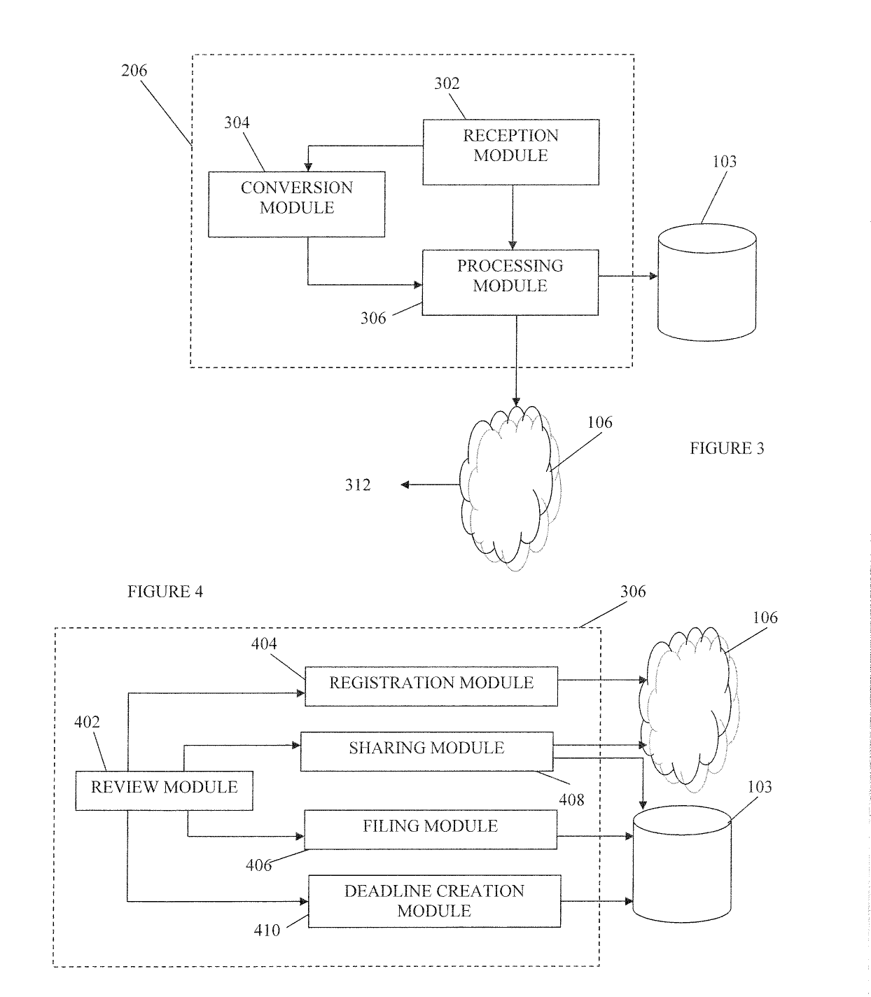

Referring now to FIG. 3, there is illustrated in more detail a document/data processing application 206. This application assists the real estate agent in all aspects of filing and classification of documents and data. Examples of documents for classification are contracts, purchase offers made, purchase offers received, a surveyor's certificate of location, photos of a property, forms, legalized or notarized documents, etc. Examples of data are the details of a property, such as land size, number of rooms, asking price, address, surrounding environment, etc. Another example of data are a list of contacts, appointments, deadlines, statistics, and any other information used in the daily practice of real estate agents.

The document/data processing application 206 may also help the real estate agent meet some of the administrative obligations involved in a property transaction. For example, instead of having to access MLS and Matrix to register a new property, the application 206 may extract the data from incoming data/documents and automatically register the property on MLS and/or Matrix. An affiliated real estate agent also needs to send various information to a representative organization, i.e. the broker. The document/data processing application 206 may also take charge of this task automatically upon receiving the necessary information. When providing a purchase offer on a given property, the application 206 may take the information regarding the property and automatically transmit the purchase offer to the selling agent, without the purchasing agent needing to identify the selling agent and his or her contact information. In addition, the application 206 may receive an incoming document in a first format and convert it into a second format such that it meets the requirements for transmission or registration. In some cases, the application 206 may perform multiple steps in the process, in the proper order, simply upon receiving the appropriate information.

In one embodiment, a reception module 302 receives data/documents and identifies the format of the incoming data/document. For example, if the document is a fax, it may be converted into PDF form by a conversion module 304. An email or email attachment may also be converted into another format by the conversion module 304. Alternatively, the data received may be information to update an existing file, such as an offer for sale or a revision to an asking price. The data/document is passed on to a processing module 306 for further processing. Further processing may involve saving the document in the database 103, or it may involve transferring information to an external destination 312, such as another agent, an administrative level in the transaction chain, MLS, Matrix, the broker, etc.

FIG. 4 illustrates the processing module 306 in more detail. A review module 402 reviews the data/document, determines a course of action, and dispatches it accordingly. For example, if the document received is a sale contract to be registered in accordance with a given law, a registration module 404 will transmit the document for registration to the appropriate instance via the network 106. The document may then be handed off to a filing module 406 for filing in the database 103. In another example, the document received is a purchase offer provided by the agent of an interested buyer. The review module 402 may hand off this document to a sharing module 408 such that the purchase offer be sent to the selling agent. This may be done via the network 106 and/or directly in the database 103. Once the document for sharing has been transmitted to the appropriate parties, it may be handed off to the filing module 406 for filing.

Another module is responsible for creating deadlines from incoming data/documents. If the review module 402 determines that information provided warrants that a deadline be created, the deadline creation module 410 is asked to create the deadline and update the database 103, accordingly. In yet another example, the received data/document is only for filing and the filing module 406 handles this task without going through any of the other modules.

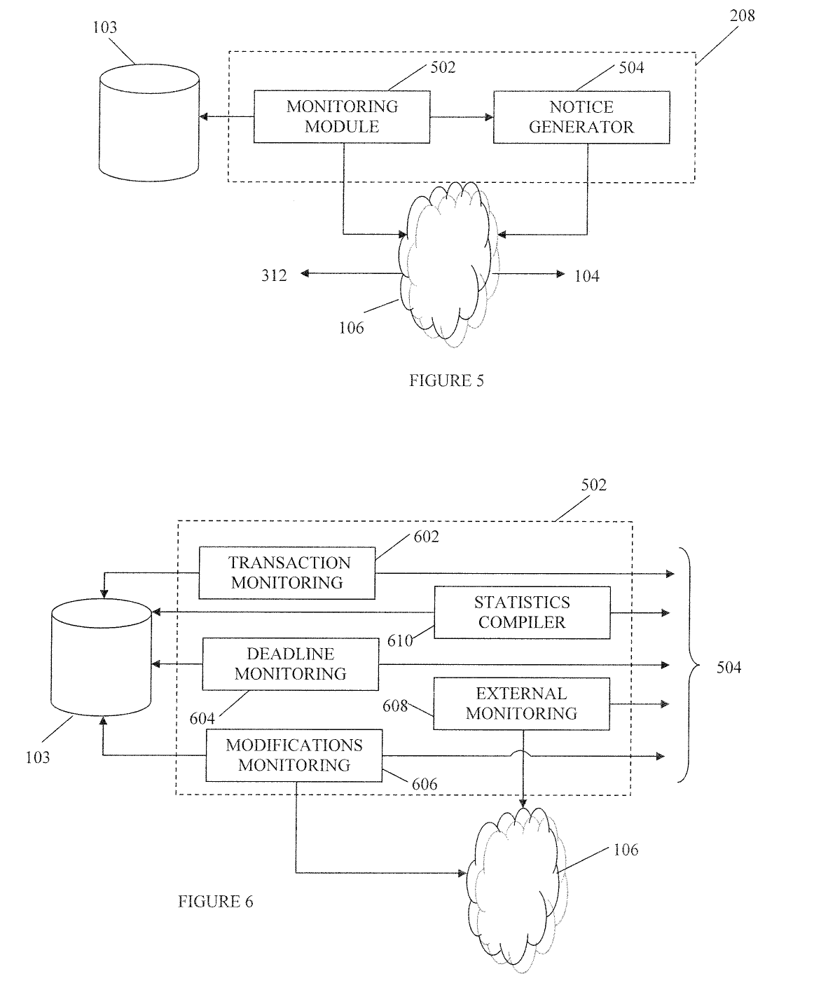

FIG. 5 illustrates an exemplary embodiment of the monitoring application 208 from FIG. 2. In one embodiment, this application assists a real estate agent in monitoring deadlines, such as those for signing and/or renewing real estate brokerage contracts, meetings with property owners, meetings with potential buyers, purchase offer expirations, counter-offer expirations, inspections, mortgage acceptance, notarized sales, etc. Alternatively, a subset or superset of these deadlines may be monitored.

A monitoring module 502 monitors the information in the database 103. In some instances, a reminder is sent to the user. Pre-configuration of the system 102 allows the user to set his or her preferences for the reminder. For example, the reminder may be a telephone call to the real estate agent's cellular telephone with a recorded message reminding the agent of the upcoming deadline. Alternatively, the real estate agent may prefer an email reminder. Frequency of the reminder, i.e. x days before the deadline or x hours before the deadline, may also be set as a preference by the user. When a deadline comes up that warrants a reminder, a notice generator 504 will generate a notice in accordance with the user's preferences and send the notice via the network 106.

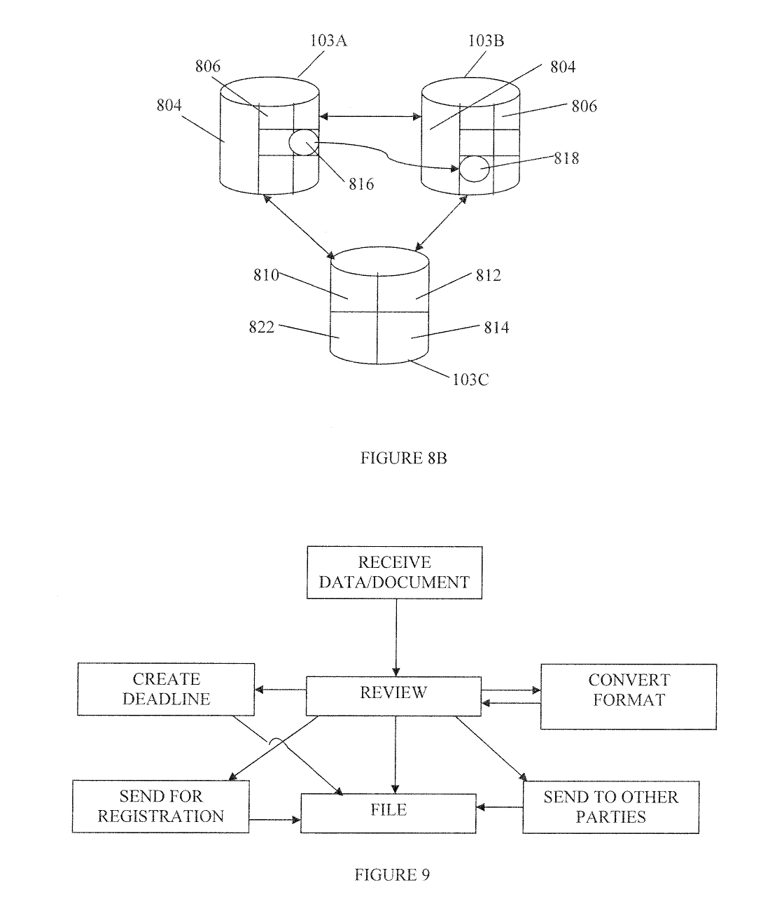

In another example, the monitoring module 502 monitors new properties offered for sale in accordance with a set of pre-determined criteria set by the user, such as geographical location, asking price, land size, etc. This monitoring may be done from an external location, such as on MLS, Matrix, or another source, or directly in the database 103, using the public space offered to each agent (explained in more detail reference to FIG. 8). When a property goes on sale that meets the pre-determined criteria, the monitoring module 502 advises the notice generator 504 and a notice goes out to the user.

FIG. 6 illustrates a more detailed exemplary embodiment of the monitoring module 502. The deadline monitoring module 604 is used as explained above. The external monitoring module 608 is used to monitor external sources, also explained above. The external monitoring module 608 may also be used to advise the user that a new listing for which the user is the selling agent has been registered and is now officially available online for the public. In one embodiment, each user is allowed to be advised of a given number of new listings for a given time period, such as 24 listings per year, or 3 listings per month. Such features may be configured into the system 102 by an administrator.

A transaction monitoring module 602 may be used to keep track of transactions that are made, such as properties that are taken off of the market due to a sale. For example, a selling agent may be interested in knowing when another property on sale in the same geographical area, or more particularly on the same street, gets sold. This information may hold some value for the sale of the property for which he or she is responsible, by considering the sale price compared to the original asking price, for example. In another example, the transaction monitoring module 602 may be used to monitor purchase offers made against properties for which the user is the selling agent. When another agent sends in a purchase offer, the transaction monitoring module 602 may advise the notice generator 504 and a notice may be sent automatically to the selling agent.

Another module, namely the modification monitoring module 606, is used to monitor changes made to information of properties offered for sale. For example, if a price is reduced for a given property, which the user has flagged as being of potential interest, a notice may be sent out to the user automatically. Alternatively, if another agent changes his or her affiliation and is now working under a different banner, a user may want to be advised of this information in order to update a contact list, or for other purposes.

A statistics compiler 610 may also be present in the monitoring module 502. By monitoring the database 103, statistics may be compiled concerning the user's own properties, or other properties offered for sale. For example, a user may ask to compile statistics on a competing agent, or with respect to all properties sold in a given geographical area, or sold for more or less than a given price. With respect to the user's own properties, statistics may be compiled for predetermined time periods, i.e. sales per month, year, etc, or according to any other criteria, such as sale prices, geographical area, counter-offers, etc. This allows the user to remain informed about his or her own practice and make changes to optimize sales and service.

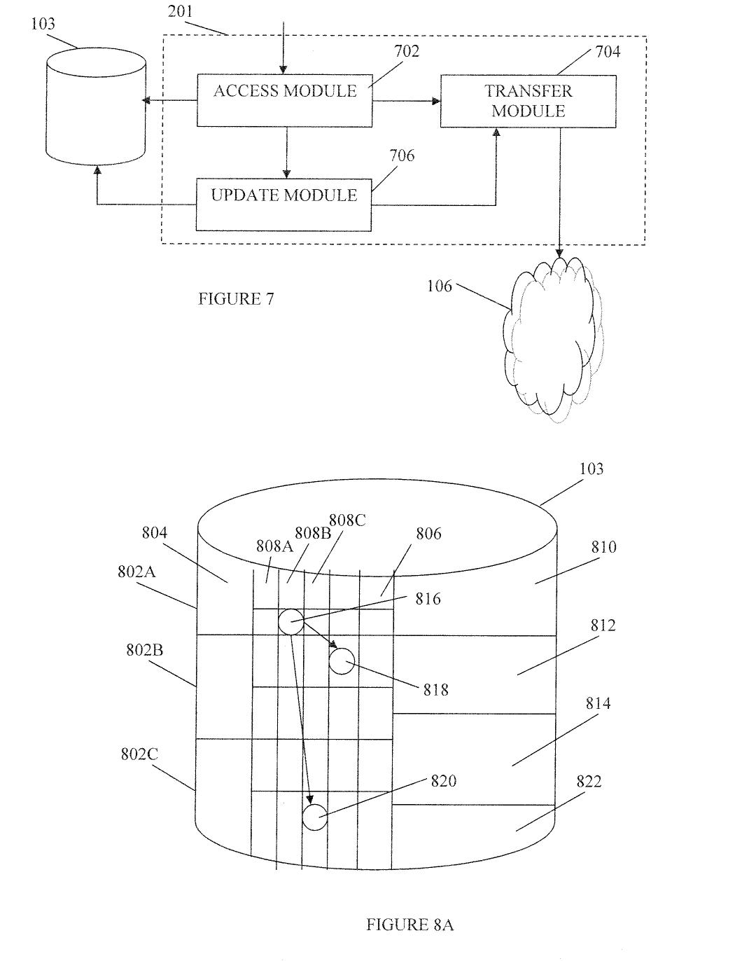

FIG. 7 illustrates an exemplary embodiment for the database access application 210 of FIG. 2. The user may access the information kept in the database 103 from any location (fixed or mobile), and from a variety of types of communication mediums 104. Information concerning any ongoing transaction, and the accompanying documents, are available to the user at all times. An access module 702 fields requests from users. Requests may include retrieval of information, update of information, or transfer of documents. Retrieval is done by accessing the database 103 directly. Updates may be handled by an update module 706, while transfers are handled by a transfer module 704. Any documents may be transferred directly to a potential buyer or to another agent via the network 106 and using various communication mediums. For example, a document located in the database 103 may be sent by fax to another party from the user's online access to the database 103. Alternatively, the document may be sent by email using an email address located in the user's contacts.

FIG. 8a is an exemplary embodiment of a layout for a database 103. In this embodiment, a plurality of users each have a reserved amount of space 802a, 802b, . . . , 802n in the database 103, and the space may be separated into private space 804 and public space 806. In the public space 806, each property for sale may have its own listing 808a, 808b, . . . , 808n. This listings may also include listings of offers made for properties for which the user is not the selling agent but rather the buying agent. Information in the public space 806 may be available for viewing by other users, while information in the private space may be kept confidential. Other public spaces may be available, such as contact information for a variety of brokers 810, guides of the practice and governing laws 812, and information regarding the governing bodies for the practice 814, such as a local or national chapter of a professional order, etc. The person skilled in the art will understand that other types of information may be available, in a public or private manner, and that the examples listed above should not be construed in a limiting manner.

In the case of a transaction involving a buying agent and a selling agent both being users of the property transaction management system 102, public files of the buyers and sellers may be linked temporarily. For example, once a purchase offer is received from a buying agent, the selling agent's public record for the coveted property 816 is linked with the buying agent's public record for the purchase offer 818. In this case, a change made to either file may get automatically updated in the linked file. If another agent also makes a purchase offer, this file 820 may also be linked. In one embodiment, a reserved transaction space 822 may be available for an ongoing transaction, where public information from both parties is temporarily transferred to a common public space to allow all of the information to be regrouped together.

FIG. 8b is an alternative embodiment of a layout for multiple databases 103a, 103b, 103c, Databases 103a and 103b are each used for a single user and include private space 804 and public space 806. Similarly to the example of FIG. 8a, public files may be linked between databases 103a, 103b. In addition, another database 103c regroups the public information for all, such as the contact information 810, the guidelines and laws 812, the professional orders information 814, and the transaction space 822. Other configurations for the database(s) 103 will be readily understood by those skilled in the art.

FIG. 9 is a flowchart illustrating a method for document/data processing, as performed by the document/data processing application 206. In a first step data is received 902. The data/data received is reviewed 904 and if necessary, it is converted to another format 906. The data/document is then processed in accordance with the available options, which are filing 910, sharing with other parties 912, creating a deadline 914, and sending to a governing body 908. After sharing with other parties 912, deadline creation 914, and/or transmission to a governing body 908, the data/document may be filed or saved in the database 910.

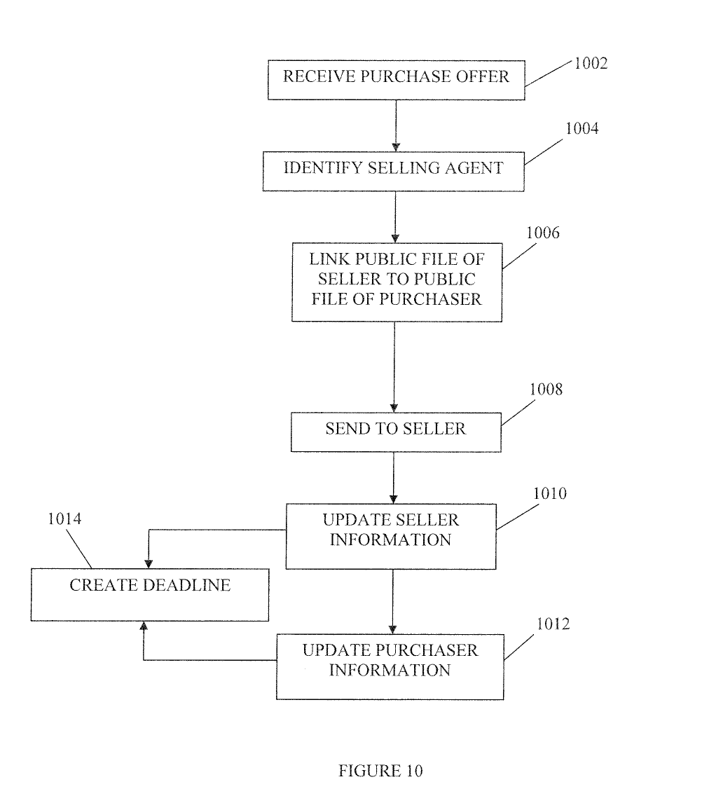

FIGS. 10, 11, 12, and 13 illustrate different methods performed by the monitoring application 208. FIG. 10 relates more particularly to the method for monitoring transactions, as performed by the transaction monitoring module 602. A purchase offer may be received from a buying agent 1002. The selling agent can be identified 1004 using the property information (i.e. address or property code). In one embodiment, the public file of the seller and the public file of the purchaser may be linked 1006. The purchase offer is eventually transmitted to the seller 1008. The seller's file is accordingly updated 1010 to reflect receipt of a purchase offer, and deadlines are created if necessary 1014. The purchaser's file is also updated to indicate that the purchase offer has been received by the seller 1012.

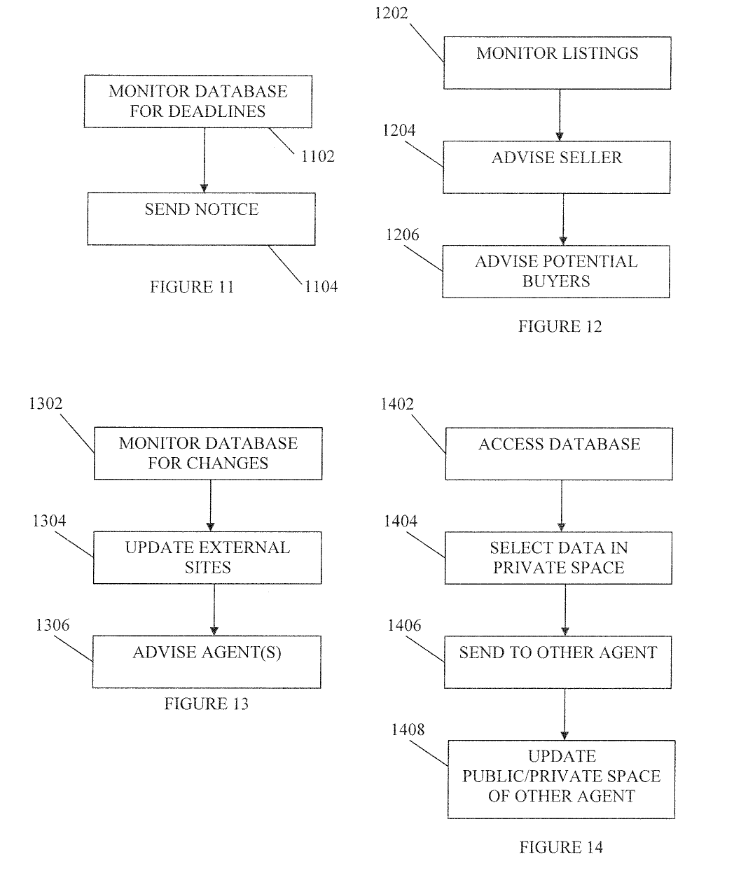

FIG. 11 illustrates an exemplary embodiment for monitoring deadlines, as performed by the deadline monitoring module 604. In a first step, the deadlines are monitored 1102. In a second step, a deadline will trigger a reminder to be sent 1104, in accordance with the user's pre-set preferences.

FIG. 12 illustrates an exemplary embodiment for external monitoring, as performed by the external monitoring module 608. Registrations on MLS or another external site are monitored 1202. When a new listing officially becomes registered, the seller is advised 1204. In one embodiment, users of the system who have asked to be notified of properties being offered for sale which meet certain predefined criteria are also notified 1206.

FIG. 13 illustrates an exemplary embodiment for monitoring changes, as performed by the modifications monitoring module 606. In a first step, the database is monitored for any changes 1302. A detected change may trigger an update to an external site 1304 such as MLS if a sale price has been changed or if a property is no longer offered for sale. Selling and/or buying agents are then advised of the change made to the external site and/or the change made to the database 1306.

FIG. 14 illustrates an exemplary embodiment for managing access to the database, as performed by the database access application 210. In a first step, a request to access the database is received 1402. Data or documents available in the private or public space of a user are retrieved 1404. In one embodiment, the information is sent to an outside party 1406. In another embodiment, the information is transferred to the public or private space of another user 1408.

It should be understood that while the applications presented herein are illustrated and described as separate entities, they may be combined or separated in a variety of ways. For example, the database access application 210 and the data/document processing application 206 may be merged into a single application and common steps or features may be performed by a same module. For example the step of creating a deadline 1014 performed by the transaction monitoring module 602 may be performed by the deadline monitoring module 604. In addition, the modules presented herewith may be combined in various manners without departing from the scope of the present invention and are presented in the accompanying figures for illustrative purposes only.

Some of the features of the modules may be automated using techniques such as Optical Character Recognition (OCR) and detection of key words in the documents. For example, detecting the format and content of a given contract would trigger that the contract be sent to an administrative body for registration or to another party. Contact information for the other party may be found in the document itself. Other contact information may be pre-stored in the system for use when appropriate. The system may be configured with the chain of events that typically occur during a transaction such that it be able to recognize which event has occurred and which event is to occur next.

Alternatively, certain features of the modules are triggered by the user selecting certain actions using a detailed Graphical User Interface (GUI) with a pull-down menu or other format. For example, to transfer a document to another party, the user may retrieve the document from storage and select an option “send”. The contact information for the recipient may also be available via the GUI and the user can transmit information accordingly.

The various databases described herein should be understood as collections of data or information organized for rapid search and retrieval by a computer. They are structured to facilitate storage, retrieval, modification, and deletion of data in conjunction with various data-processing operations. They consist of a files or sets of files that can be broken down into records, each of which consists of one or more fields. Users may retrieve database information through queries. Using keywords and sorting commands, users can rapidly search, rearrange, group, and select the field in many records to retrieve or create reports on particular aggregates of data according to various rules. The databases may be any organization of data on a data storage medium, such as one or more servers. Monitoring features may be implemented using field detection and comparisons to previous versions.

In one embodiment, the databases are secure web servers and HyperText Transport Protocol Secure (HTTPS) capable of supported Transport Layer Security (TLS) is the protocol used for access to the data. Communications to and from the secure web servers may be secured using Secure Sockets Layer (SSL). An SSL session may be started by sending a request to the Web server with an HTTPS prefix in the URL, which causes port number 443 to be placed into the packets. Port 443 is the number assigned to the SSL application on the server. Identify verification of a user may be performed using usernames and passwords for al users. Various levels of access rights may be provided to multiple levels of users.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Framebuffer Protocol).

While illustrated in the block diagrams as groups of discrete components communicating with each other via distinct data signal connections, it will be understood by those skilled in the art that the embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, a computer readable medium or an electrical or electro-magnetic signal. The embodiments described above are intended to be exemplary only. The scope of the invention is therefore intended to be limited solely by the scope of the appended claims.

I/We claim:

1. A method for managing property transactions, the method comprising:
providing to each user a reserved space for collecting and classifying information relating to a plurality of properties offered for sale, the reserved space including a public space containing information accessible by other users and a private space containing information inaccessible by other users;
receiving documents from each user and automatically classifying them according to a predetermined classification system;
automatically transferring documents for registration to governing bodies and completing administrative formalities using information provided in documents received;
temporarily linking listings in public spaces for a buying agent and selling agent during the course of a transaction, from receipt of a purchase offer to final rejection or conclusion of the transaction;
managing access to the public and private space of a user and transfer of information to another party from a remote location; and
recording deadlines from the documents received and automatically notifying users of impending deadlines in accordance with predefined user preferences.

2. A property transaction management system comprising:
a processor in a computer system;
a memory accessible by the processor; and
at least one application coupled to the processor and configured for:
providing to each user a reserved space for collecting and classifying information relating to a plurality of properties offered for sale, the reserved space including a public space containing information accessible by other users and a private space containing information inaccessible by other users;
receiving documents from each user and automatically classifying them according to a predetermined classification system;
automatically transferring documents for registration to governing bodies and completing administrative formalities using information provided in documents received;
temporarily linking listings in public spaces for a buying agent and selling agent during the course of a transaction, from receipt of a purchase offer to final rejection or conclusion of the transaction;
managing access to the public and private space of a user and transfer of information to another party from a remote location; and
recording deadlines from the documents received and automatically notifying users of impending deadlines in accordance with predefined user preferences.
